(19) United States
(12) Patent Application Publication
(10) Pub. No.: US 2026/0118869 A1
(43) Pub. Date: Apr. 30, 2026

(54) REMOTE CONTROLLER, TERMINAL, AND ONBOARD DEVICE

(71) Applicant: TOYOTA JIDOSHA KABUSHIKI KAISHA, Toyota-shi (JP)

(72) Inventors: Shuichi TAMAGAWA, Kitanagoya-shi (JP); Yoshihisa SHINODA, Sunto-gun (JP)

(73) Assignee: TOYOTA JIDOSHA KABUSHIKI KAISHA, Toyota-shi (JP)

(21) Appl. No.: 19/352,627

(22) Filed: Oct. 8, 2025

(30) Foreign Application Priority Data
Oct. 31, 2024 (JP) 2024-191457

(51) Int. Cl. G05D 1/221; B63B 35/00; B63B 79/10; B63H 25/02; G05D 1/82; G05D 109/30

(52) U.S. Cl. CPC G05D 1/221; B63B 35/00; B63B 79/10; B63H 25/02; G05D 1/82; B63B 2035/008; B63B 2203/00; G05D 2109/30

(57) ABSTRACT

The controller of the terminal acquires a current position of the ship and a current position of the terminal in response to receiving an input of an operation for controlling a predetermined propulsive force of the ship. The controller of the terminal calculates a relative distance between the ship and the terminal according to a current position of the ship and a current position of the terminal. The controller of the terminal determines a control amount of a predetermined propulsive force according to the calculated relative distance. The controller of the terminal transmits to the ship a remote signal including a command for controlling the predetermined propulsive force according to the determined control amount.

### CROSS-REFERENCE TO RELATED APPLICATION

This application claims priority to Japanese Patent Application No. 2024-191457 filed on Oct. 31, 2024. The disclosure of the above-identified application, including the specification, drawings, and claims, is incorporated by reference herein in its entirety.

### BACKGROUND

### 1. Technical Field

The present disclosure relates to a remote controller, a terminal, and an onboard device.

### 2. Description of Related Art

A technique is known for performing operations such as a course and a propulsive force of a ship on an operation screen displayed on a tablet terminal (for example, see Japanese Unexamined Patent Application Publication No. 2020-132095 (JP 2020-132095 A)).

### SUMMARY

An object of the present disclosure is to provide a technique that is effective for ensuring safety when a ship is remotely operated.

An aspect of the present disclosure may be a remote controller configured to remotely operate a ship. An example of the remote controller in such a case may include a controller configured to execute:
detecting an operation of designating a magnitude of a predetermined propulsive force of the ship;
detecting a current position of the remote controller via a sensor mounted on the remote controller;
receiving, through wireless communication with the ship, a current position of the ship detected by a sensor mounted on the ship;
calculating a relative distance between the current position of the ship and the current position of the remote controller;
correcting, according to the relative distance, the magnitude of the predetermined propulsive force designated by the operation; and
transmitting, to the ship, a remote signal including a command for controlling the predetermined propulsive force according to the magnitude of the predetermined propulsive force after the correction.

Another aspect of the present disclosure may be a terminal configured to remotely operate a ship. An example of the terminal in such a case may include a controller configured to execute:
receiving an input of an operation for controlling a predetermined propulsive force of the ship;
acquiring a current position of the ship and a current position of the terminal in response to receiving the input of the operation;
calculating a relative distance between the current position of the ship and the current position of the terminal;
determining a control amount of the predetermined propulsive force according to the relative distance; and
transmitting, to the ship, a remote signal including a command for controlling the predetermined propulsive force according to the control amount that is determined.

Still another aspect of the present disclosure may be an onboard device configured to be mounted on a ship that is remotely operated by a terminal. An example of the onboard device in such a case may include a controller configured to execute:
receiving, from the terminal, a remote signal including a control amount for controlling a predetermined propulsive force of the ship and a current position of the terminal;
acquiring a current position of the ship in response to receiving the remote signal;
calculating a relative distance between the current position of the ship and the current position of the terminal;
correcting the control amount according to the relative distance; and
controlling the predetermined propulsive force according to the control amount after the correction.

In addition, yet another aspect of the present disclosure may include an information processing method in which a computer executes processing of the terminal, a program for causing a computer to execute the information processing method, or a non-transitory storage medium storing the program.

According to the present disclosure, it is possible to provide a technique that is effective for ensuring the safety when a ship is remotely operated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an example of a configuration of a remote ship operation system according to an embodiment;

FIG. 2A is a diagram showing an example of a remote operation screen during the translational operation in the front-rear direction according to the embodiment;

FIG. 2B is a diagram showing an example of a remote operation screen during the translational operation in the right-left direction according to the embodiment;

FIG. 2C is a diagram showing an example of a remote operation screen during the turning operation according to the embodiment;

FIG. 3A is a diagram for describing an example of a method of setting the magnitude of the propulsive force in the front-rear direction according to the embodiment;

FIG. 3B is a diagram for describing an example of a method of setting the magnitude of the propulsive force in the right-left direction according to the embodiment;

FIG. 3C is a diagram for describing an example of a method of setting the magnitude of the propulsive force for turning according to the embodiment;

FIG. 4A is a diagram for describing a first method of determining a correction coefficient for correcting the magnitude of the propulsive force according to the embodiment;

FIG. 4B is a diagram for describing a second method of determining a correction coefficient for correcting the magnitude of the propulsive force according to the embodiment;

FIG. 4C is a diagram for describing a third method of determining a correction coefficient for correcting the magnitude of the propulsive force according to the embodiment;

FIG. 5 is a sequence diagram for describing processing executed in the remote ship operation system according to the embodiment; and

FIG. 6 is a sequence diagram for describing processing executed in the remote ship operation system according to the Modification.

### DETAILED DESCRIPTION OF EMBODIMENTS

A technique for remotely operating a ship using a mobile terminal, such as a smartphone or a tablet terminal, is being developed. As an example, a technique is known in which an operation screen including various GUI components such as display fields for a plurality of pieces of information that indicate the state of a ship, a plurality of buttons for selecting a magnitude of a propulsive force of the ship, and a plurality of buttons for selecting a course of the ship is displayed on a terminal, and the magnitude of the propulsive force and the course selected by a user on the operation screen are transmitted from the terminal to the ship through wireless communication. However, in a case where the relative distance between the terminal and the ship is large, when the same remote operation as in a case where the relative distance between the terminal and the ship is small is permitted, there is a possibility that it is difficult to ensure the safety of the ship and the periphery of the ship. Therefore, there is room for improvement in ensuring safety when the ship is remotely operated.

In the terminal according to an aspect of the present disclosure, the controller is configured to receive an input of an operation for controlling a predetermined propulsive force of the ship. The predetermined propulsive force may include at least one of a propulsive force when the ship translates in the front-rear direction, a propulsive force when the ship translates in the right-left direction, and a propulsive force when the ship turns in the right-left direction. The controller is configured to acquire a current position of the ship and a current position of the terminal in response to receiving the input of the operation. In an example, the controller may acquire the current position detected by the sensor mounted on the ship through wireless communication with the ship. The controller may acquire a current position of the terminal through a sensor mounted on the terminal.

The controller calculates a real-time relative distance between the ship and the terminal according to the current position of the ship and the current position of the terminal, both of which are acquired. The controller determines a control amount of a predetermined propulsive force according to the calculated relative distance. In an example, the control amount of the predetermined propulsive force may include a magnitude of the predetermined propulsive force. In this case, the controller may determine the magnitude of the predetermined propulsive force such that, when the relative distance is large, the ratio of the magnitude of the predetermined propulsive force to the operation amount of the input operation is smaller compared to when the relative distance is small. In addition, in another example, the control amount of the predetermined propulsive force may include a control speed of the predetermined propulsive force. In this case, the controller may set the control speed to be slower when the relative distance is large compared to when the relative distance is small.

When the control amount of the predetermined propulsive force is determined as described above, the controller transmits, to the ship, a remote signal including a command for controlling the predetermined propulsive force according to the determined control amount.

According to an aspect of the present disclosure, it is possible to automatically change the range of the control amount of the predetermined propulsive force that can be operated by the remote operation according to the relative distance between the ship and the terminal. In an example, the ratio of the magnitude of the predetermined propulsive force to the operation amount of the remote operation can be automatically reduced when the relative distance is large compared to when the relative distance is small. As a result, the maximum value of the predetermined propulsive force that can be operated by the remote operation is reduced when the relative distance is large compared to when the relative distance is small. In another example, it is possible to set the control speed of the predetermined propulsive force to be slower when the relative distance is large compared to when the relative distance is small. As a result, when the relative distance is large, the response of the ship to the remote operation becomes slower compared to when the relative distance is small.

Therefore, it is possible to improve the safety of the ship and the periphery of the ship in a case where the user of the terminal has difficulty in visually grasping the situation of the ship and the periphery of the ship, such as in a case where the relative distance between the ship and the terminal is large. Further, the operability of the remote operation can be ensured in a case where the user of the terminal can easily visually grasp the situation of the ship and the periphery of the ship, such as in a case where the relative distance between the ship and the terminal is small.

Hereinafter, specific embodiments of the present disclosure will be described with reference to the drawings. Unless otherwise specified, the hardware configuration, module configuration, functional configuration, and the like described in the following embodiments are not intended to limit the technical scope of the disclosure.

### Embodiment

In the present embodiment, an example in which the present disclosure is applied to a remote ship operation system will be described. The remote ship operation system in the present embodiment is a system that remotely operates a ship using a mobile terminal.

### Outline of Remote Ship Operation System

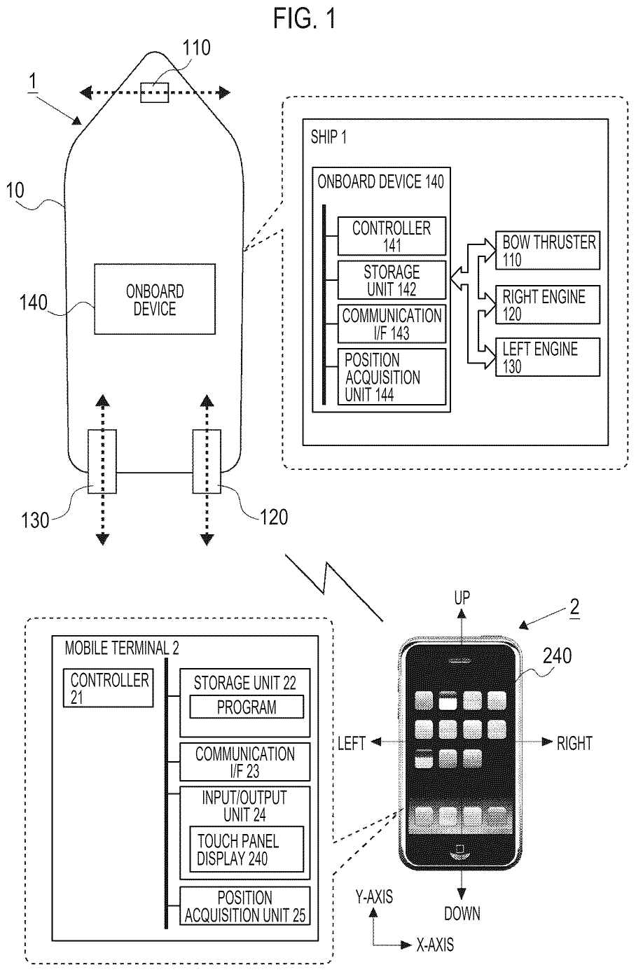

FIG. 1 is a diagram showing an overall configuration of an example of a remote ship operation system according to the present disclosure. A remote ship operation system according to the present disclosure is configured to include a ship 1 and a mobile terminal 2 as shown in FIG. 1.

The ship 1 includes a bow thruster 110 mounted on a bow portion of a hull 10, two engines 120, 130 mounted on a stern portion of the hull 10, and an onboard device 140. The bow thruster 110 is a propulsion device that generates a propulsive force for propelling the bow portion of the hull 10 in the right-left direction. The engines 120, 130 are propellers that generate a propulsive force for propelling the stern portion of the hull 10 in the front-rear direction. Hereinafter, among the two engines 120, 130, the engine 120 installed on the right side of the hull 10 is referred to as a right engine 120, and the engine 130 installed on the left side of the hull 10 is referred to as a left engine 130. In addition, in the description of the present embodiment, the bow thruster 110, the right engine 120, and the left engine 130 may be collectively referred to as “engines”. The onboard device 140 is a computer that controls the engine in response to the remote signal transmitted from the mobile terminal 2. The remote signal is a signal including a command for designating the propulsion direction of the ship 1 and a command for designating the magnitude of the propulsive force in the propulsion direction.

The configuration of the ship 1 is not limited to the example shown in FIG. 1, and the disposition and the number of the engines may be appropriately changed according to the embodiment as long as the configuration is capable of translating in the front-rear and right-left directions and turning in the right-left direction.

The ship 1 configured as described above moves forward (translates forward) as the right engine 120 and the left engine 130 generate the propulsive force for propelling the stern portion forward in a state where the bow thruster 110 is stopped. The ship 1 moves rearward (translates rearward) as the right engine 120 and the left engine 130 generate the propulsive force for propelling the hull 10 rearward in a state where the bow thruster 110 is stopped.

The ship 1 translates to the left direction as the bow thruster 110 generates a propulsive force for propelling the bow portion to the left direction, and the right engine 120 and the left engine 130 generate a propulsive force for propelling the stern portion to the left direction. That is, the ship 1 translates to the left direction when the right engine 120 generates a propulsive force for propelling the hull 10 rearward, and the left engine 130 generates a propulsive force for propelling the hull 10 forward. The ship 1 translates to the left as the bow thruster 110 generates a propulsive force for propelling the bow portion to the right direction, and the right engine 120 and the left engine 130 generate a propulsive force for propelling the stern portion to the right direction. That is, the ship 1 translates to the right direction as the right engine 120 generates a propulsive force for propelling the hull 10 forward, and the left engine 130 generates a propulsive force for propelling the hull 10 rearward.

The ship 1 turns to the left direction as the bow thruster 110 generates a propulsive force for propelling the bow portion to the left direction, and the right engine 120 and the left engine 130 generate a propulsive force for propelling the stern portion to the right direction. That is, the ship 1 turns to the left direction as the right engine 120 generates a propulsive force for propelling the hull 10 forward, and the left engine 130 generates a propulsive force for propelling the hull 10 backward. The ship 1 turns to the right direction as the bow thruster 110 generates a propulsive force for propelling the bow portion to the right direction, and the right engine 120 and the left engine 130 generate a propulsive force for propelling the stern portion to the left direction. That is, the ship 1 turns to the right direction as the right engine 120 generates a propulsive force for propelling the hull 10 rearward, and the left engine 130 generates a propulsive force for propelling the hull 10 forward.

The mobile terminal 2 is a portable computer used by a user who remotely operates the ship 1, such as a smartphone or a tablet terminal. The mobile terminal 2 in the present embodiment is equipped with a touch panel display 240 as an input/output device. Hereinafter, the right-left direction when the surface on which the touch panel display 240 is provided in the mobile terminal 2 is viewed from the front is referred to as the X-axis, and the up-down direction is referred to as the Y-axis.

The mobile terminal 2 of the present embodiment has a function of outputting (displaying) a user interface screen for remote operation on the touch panel display 240, a function of detecting a slide touch operation input on the user interface screen, a function of setting the propulsion direction of the ship 1 and the magnitude of the propulsive force in the propulsion direction in response to the detected slide touch operation, a function of correcting the set magnitude of the propulsive force according to the relative distance between the ship 1 and the mobile terminal 2, and a function of transmitting, to the ship 1 (onboard device 140), a remote signal including the set propulsion direction and the magnitude of the propulsive force after correction. The details of these functions will be described later.

With the remote ship operation system in the present embodiment, the user can remotely control the ship 1 by inputting the slide touch operation on the user interface screen displayed on the touch panel display 240 of the mobile terminal 2.

### Configuration of Remote Ship Operation System

Here, an example of the configurations of the ship 1 and the mobile terminal 2 included in the remote ship operation system will be described with reference to FIG. 1.

As described above, the ship 1 in the present embodiment includes the bow thruster 110, the right engine 120, the left engine 130, and the onboard device 140. The onboard device 140 is connected to the bow thruster 110, the right engine 120, and the left engine 130 through an in-ship network based on a standard, such as a controller area network (CAN), a local interconnect network (LIN), or FlexRay.

The onboard device 140 in the present embodiment is configured as a computer including a processor (CPU, GPU, or the like), a main storage device (RAM, ROM, or the like), and an auxiliary storage device (EPROM, a hard disk drive, a removable media, or the like). As shown in FIG. 1, the onboard device 140 is configured to include a controller 141, a storage unit 142, a communication I/F 143, a position acquisition unit 144, and the like.

The controller 141 executes a dedicated program stored in the storage unit 142 to implement various functions as described below. As an example, the controller 141 is configured to include a hardware processor, such as a central processing unit (CPU) or a digital signal processor (DSP). The controller 141 may be further configured to include RAM, ROM, a cache memory, or the like.

The storage unit 142 is configured to include an auxiliary storage device and store various kinds of information. The storage unit 142 may also be a storage area configured in an auxiliary storage device. The information stored in the storage unit 142 includes a program for remote operation and data used by the program, in addition to the OS.

The communication I/F 143 includes a communication interface for connecting the onboard device 140 to an in-ship network and a wireless communication interface for connecting the onboard device 140 to an off-ship network (for example, a wide area network (WAN) that is a global public communication network such as the Internet, and a wireless communication network such as Wi-Fi (registered trademark)). In an example, the communication I/F 143 may include a communication interface for mobile communication (for example, 3G, LTE, 5G, 6G, or the like) and a wireless communication interface for short-range wireless communication. The communication I/F 143 of the present embodiment communicates with the bow thruster 110, the right engine 120, and the left engine 130 through the in-ship network. Further, the communication I/F 143 of the present embodiment is connected to the off-ship network by using wireless communication, and communicates with the mobile terminal 2 through the off-ship network.

The position acquisition unit 144 is configured to include equipment that acquires the current position of the ship 1. In an example, the position acquisition unit 144 may be configured to include a global positioning system (GPS) receiver that detects the geographic coordinates (for example, latitude and longitude) of the current position of the ship 1. In another example, the position acquisition unit 144 may be configured to include a wireless communication circuit that detects the geographic coordinates of the current position of the ship 1 by using a Wi-Fi (registered trademark) location information service.

In the ship 1 configured as described above, the onboard device 140 acquires the current position of the ship 1 through the position acquisition unit 144 in response to the communication I/F 143 receiving the request signal transmitted from the mobile terminal 2. The onboard device 140 transmits the position information including the acquired current position to the mobile terminal 2 through the communication I/F 143. The request signal in the present embodiment is a signal requesting the provision of the current position of the ship 1.

The onboard device 140 controls the bow thruster 110, the right engine 120, and the left engine 130 in response to the remote signal transmitted from the mobile terminal 2. Here, a command for designating the forward direction (or the rearward direction) as the propulsion direction and a command for designating the magnitude of the propulsive force in the forward direction (or the rearward direction) may be included in the remote signal. In this case, the controller 141 of the onboard device 140 controls the engine to generate the propulsive force for propelling the hull 10 forward (or rearward). That is, the controller 141 of the onboard device 140 controls such that the bow thruster 110 is stopped and the right engine 120 and the left engine 130 generate the propulsive force for propelling the stern portion of the ship forward (or rearward).

In addition, a command for designating the left direction (or the right direction) as the propulsion direction and a command for designating the magnitude of the propulsive force in the left direction (or the right direction) may be included in the remote signal. In this case, the controller 141 of the onboard device 140 controls the engine to generate the propulsive force for propelling the hull 10 to the left direction (or the right direction). That is, the controller 141 of the onboard device 140 controls such that the bow thruster 110 generates the propulsive force for propelling the bow portion to the left direction (or the right direction), and the right engine 120 and the left engine 130 generate the propulsive force for propelling the stern portion to the left direction (or the right direction).

In addition, a command for designating the left turning direction (or the right turning direction) as the propulsion direction and a command for designating the magnitude of the propulsive force in the left turning direction (or the right turning direction) may be included in the remote signal. In this case, the controller 141 of the onboard device 140 controls the engine to generate the propulsive force for turning the hull 10 to the left direction (or the right direction). The controller 141 of the onboard device 140 controls such that the bow thruster 110 generates a propulsive force for propelling the bow portion to the left direction (or the right direction), and the right engine 120 and the left engine generate a propulsive force for propelling the stern portion to the right direction (or the left direction).

Next, an example of the configuration of the mobile terminal 2 will be described. The mobile terminal 2 is configured as a portable computer including a processor (CPU, GPU, or the like), a main storage device (RAM, ROM, or the like), and an auxiliary storage device (EPROM, a hard disk drive, a removable media, or the like). As shown in FIG. 1, such a mobile terminal 2 is configured to include a controller 21, a storage unit 22, a communication I/F 23, an input/output unit 24, a position acquisition unit 25, and the like.

The controller 21 executes a dedicated program stored in the storage unit 22 to implement various functions as described below. As an example, the controller 21 is configured to include a hardware processor, such as a central processing unit (CPU) or a digital signal processor (DSP). The controller 21 may be further configured to include RAM, ROM, a cache memory, or the like.

The storage unit 22 is configured to include an auxiliary storage device and store various kinds of information. The storage unit 22 may also be a storage area configured in an auxiliary storage device. The information stored in the storage unit 22 includes an application program for remote operation and data used by the program, in addition to the OS. The application program for remote operation stored in the storage unit 22 of the mobile terminal 2 corresponds to the “program” according to the present disclosure.

The communication I/F 23 includes a wireless communication interface for connecting the mobile terminal 2 to the network. In an example, the communication I/F 23 may include a communication interface for mobile communication and a wireless communication interface for short-range wireless communication. The communication I/F 23 of the present embodiment is connected to the network by using wireless communication and communicates with the onboard device 140 of the ship 1 through the network.

The input/output unit 24 receives an input operation of a user who remotely operates the ship 1 and presents information to the user. The input/output unit 24 in the present embodiment is configured to include an input/output touch panel display 240 capable of input and output.

The position acquisition unit 25 is configured to include equipment that acquires the current position of the mobile terminal 2. In an example, the position acquisition unit 25 may be configured to include a GPS receiver that detects the geographic coordinates (for example, latitude and longitude) of the current position of the mobile terminal 2. In another example, the position acquisition unit 25 may be configured to include a wireless communication circuit that detects the geographic coordinates of the current position of the mobile terminal 2 by using a Wi-Fi (registered trademark) location information service.

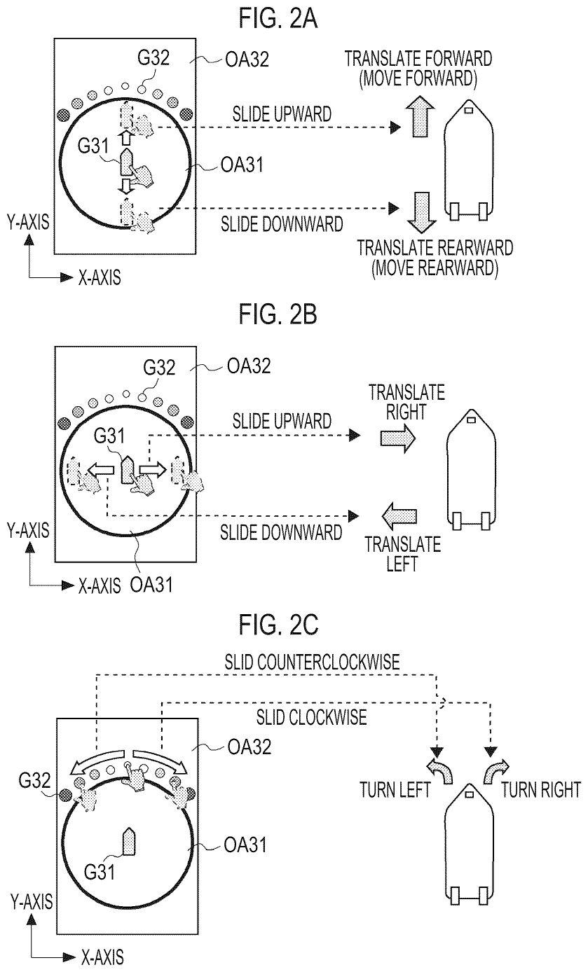

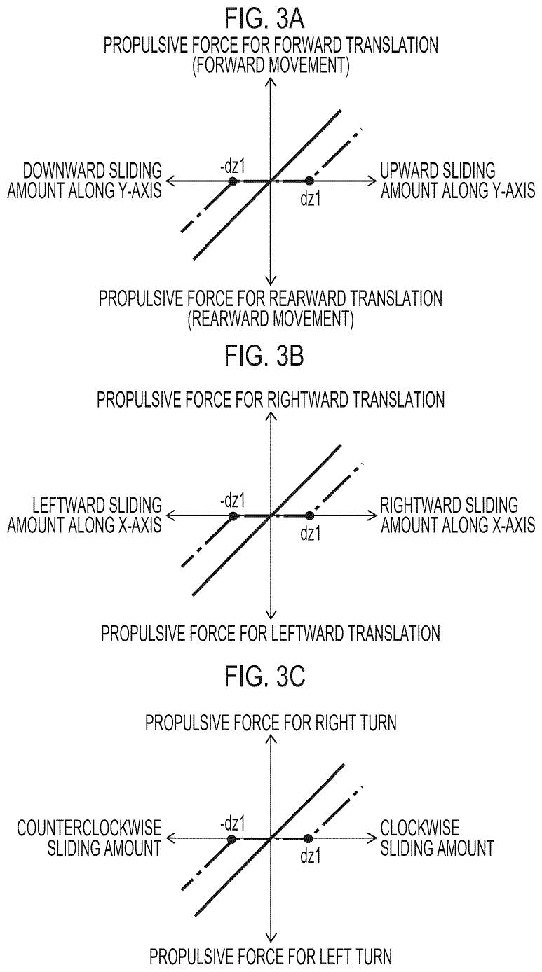

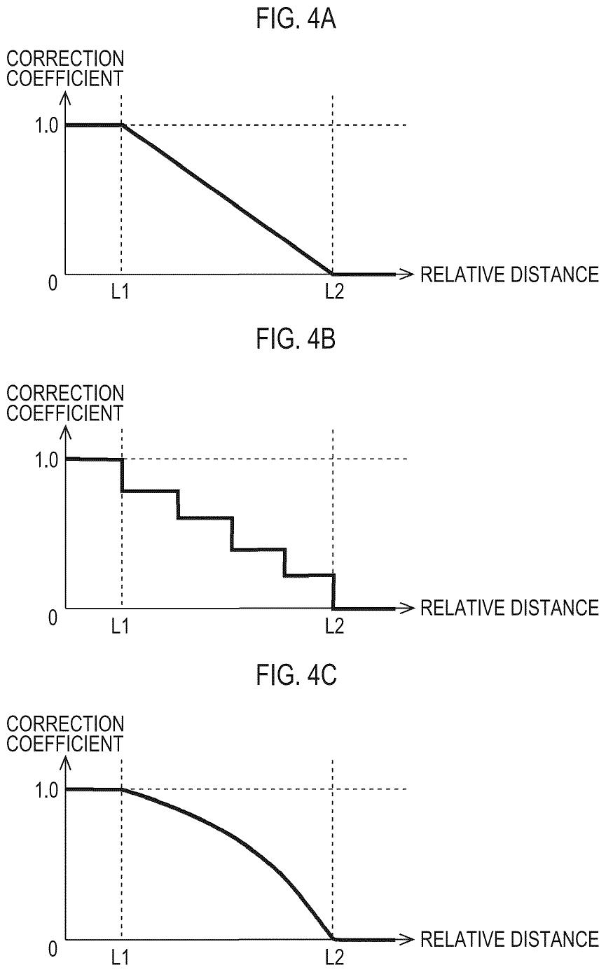

In the mobile terminal 2 configured as described above, the following functions are implemented by the controller 21 executing the application program of the storage unit 22. Hereinafter, the functions implemented by the mobile terminal 2 will be described with reference to FIGS. 2A to 4C. FIGS. 2A to 2C are diagrams showing an example of a user interface screen for remote operation (hereinafter, also referred to as a “remote operation screen”) that is output to the touch panel display 240 of the mobile terminal 2. FIGS. 3A to 3C are diagrams showing an example of a method of setting the magnitude of the propulsive force in the remote operation. FIGS. 4A to 4C are diagrams for describing a method of determining a correction coefficient for correcting the magnitude of the propulsive force in the remote operation.

In the mobile terminal 2, when the user performs an operation of starting the application program through the input/output unit 24, the controller 21 outputs the remote operation screen to the touch panel display 240 of the input/output unit 24 through the execution of the application program. As shown in FIGS. 2A to 2C, the remote operation screen includes a first operation area OA31 and a second operation area OA32. The first operation area OA31 is a screen area for designating the propulsion direction (the translational direction) of the ship 1 and the magnitude of the propulsive force of the ship 1 by a slide touch operation, and, in an example, may include an icon G31 that is a GUI component indicating the ship 1. The second operation area OA32 is a screen area for designating the turning direction of the ship 1 and the magnitude of the propulsive force of the ship 1 by a slide touch operation, and, in an example, may include a dial G32 that is a GUI component in which scale marks are arranged in an arc shape. The configuration of the remote operation screen is not limited to the example shown in FIGS. 2A to 2C, and can be appropriately changed according to the embodiment.

In a remote operation screen as shown in FIG. 2A, when an operation of sliding the icon of the first operation area OA31 in the Y-axis direction (that is, a slide touch operation of sliding the icon G31 in the Y-axis direction while touching the icon G31) is input, the controller 21 detects the sliding amount of the icon G31 in the Y-axis direction through the touch panel display 240. The controller 21 sets the propulsion direction and the propulsive force in the front-rear direction of the ship 1 according to the detected sliding amount.

Here, as shown in FIG. 3A, the touch panel display 240 in the present embodiment outputs the sliding amount when the icon G31 is slid in an upward direction along the Y-axis as a positive value. Further, the touch panel display 240 is configured to output a sliding amount when the icon G31 is slid in a downward direction along the Y-axis as a negative value. Therefore, in the present embodiment, when the sliding amount of the icon G31 in the Y-axis direction detected by the touch panel display 240 is a positive value (the sliding direction is the upward direction along the Y-axis), the controller 21 sets the propulsion direction to the forward direction of the ship 1. Then, the controller 21 sets the propulsive force to a greater value as the absolute value of the sliding amount increases. On the other hand, when the sliding amount of the icon G31 in the Y-axis direction detected by the touch panel display 240 is a negative value (the sliding direction is the downward direction along the Y-axis), the controller 21 sets the propulsion direction to the rearward direction of the ship 1 and sets the propulsive force to a greater value as the absolute value of the sliding amount increases.

When the propulsion direction and the magnitude of the propulsive force in the front-rear direction of the ship 1 are set by the method described above, the controller 21 corrects the set magnitude of the propulsive force according to the relative distance between the ship 1 and the mobile terminal 2. In an example, the controller 21 first acquires the current position of the mobile terminal 2 through the position acquisition unit 25. The controller 21 transmits the request signal to the ship 1 (onboard device 140) through the communication I/F 23. As described above, the request signal is a signal requesting the provision of the current position of the ship 1. When the position information including the current position of the ship 1 is transmitted from the onboard device 140 to the mobile terminal 2 in response to the request signal, the controller 21 acquires the position information through the communication I/F 23. When the current position of the mobile terminal 2 and the current position of the ship 1 are acquired in this way, the controller 21 calculates the relative distance between the mobile terminal 2 and the ship 1 according to the current status of the mobile terminal 2 and the current position of the ship 1. Next, the controller 21 determines the correction coefficient according to the calculated relative distance. The correction coefficient is a coefficient for correcting the magnitude of the propulsive force.

Here, a method of determining the correction coefficient will be described with reference to FIGS. 4A to 4C. The correction coefficient in the present embodiment is a coefficient equal to or greater than 0 and equal to or less than 1, and is determined to be a smaller value when the relative distance is large compared to when the relative distance is small. In an example, when the relative distance is L1 (for example, about 5 m) or less, the correction coefficient is determined to be “1”, as shown in FIG. 4A. In addition, when the relative distance is greater than L1 and smaller than L2 (for example, about 20 m), the correction coefficient is determined to decrease linearly (inversely proportional to the relative distance) to a smaller value as the relative distance increases. In addition, when the relative distance is L2 or greater, the correction coefficient may be determined to be “0”. In another example, when the relative distance is L1 (for example, about 5 m) or less, the correction coefficient is determined to be “1”, as shown in FIG. 4B. In addition, when the relative distance is greater than L1 and smaller than L2 (for example, about 20 m), the correction coefficient is determined to decrease stepwise to a smaller value as the relative distance increases. In addition, when the relative distance is L2 or greater, the correction coefficient may be determined to be “0”. Further, in another example, when the relative distance is L1 (for example, about 5 m) or less, the correction coefficient is determined to be “1”, as shown in FIG. 4C. In addition, when the relative distance is greater than L1 and smaller than L2 (for example, about 20 m), the correction coefficient is determined to decrease curvilinearly (exponentially) to a smaller value as the relative distance increases. In addition, when the relative distance is L2 or greater, the correction coefficient may be determined to be “0”. The correlation between the relative distance and the correction coefficient as shown in FIGS. 4A to 4C may be stored in the storage unit 22 of the mobile terminal 2 in the form of a map. The method of determining the correction coefficient is not limited to the example shown in FIGS. 4A to 4C, and may be appropriately changed according to the embodiment as long as the correction coefficient is set to a smaller value when the relative distance is greater than when the relative distance is smaller.

When the correction coefficient is determined by the method described above, the controller 21 corrects the magnitude of the propulsive force by multiplying the determined correction coefficient by the magnitude of the propulsive force set according to the absolute value of the sliding amount. When the correction of the magnitude of the propulsive force is completed, the controller 21 transmits a remote signal for propelling (translating) the ship 1 in the forward or rearward direction to the onboard device 140, as shown in FIG. 2A. The remote signal at that time includes a command for designating the forward or rearward direction as the propulsion direction and a command for designating the magnitude of the propulsive force after correction.

When the correction coefficient is determined to be “0” (when the relative distance is L2 or greater in FIGS. 4A to 4C), the magnitude of the propulsive force after correction becomes “0”. In this case, the controller 21 may display the GUI component indicating that the remote operation of the ship 1 is not possible on the remote operation screen without transmitting the remote signal described above to the onboard device 140. The GUI component at that time may include a message indicating that the relative distance between the ship 1 and the mobile terminal 2 is too large.

Further, on the remote operation screen as shown in FIG. 2B, an operation of sliding the icon G31 of the first operation area OA31 in the X-axis direction (the right-left direction in FIG. 2B) (that is, a slide touch operation of sliding the icon G31 in the X-axis direction while touching the icon G31) is input. The controller 21 detects a sliding amount of the icon G31 in the X-axis direction through the touch panel display 240 in response to the input. The controller 21 sets the propulsion direction and the propulsive force of the ship 1 in the right-left direction according to the detected sliding amount.

Here, the touch panel display 240 in the present embodiment is configured to output the sliding amount when the icon G31 is slid in the right direction along the X-axis as a positive value, as shown in FIG. 3B. In addition, the touch panel display 240 is configured to output a sliding amount when the icon G31 is slid in the left direction along the X-axis as a negative value. Therefore, in the present embodiment, when the sliding amount of the icon G31 in the X-axis direction detected by the touch panel display 240 is a positive value (the sliding direction is the right direction along the X-axis), the controller 21 sets the propulsion direction to the right direction of the ship 1. Further, the controller 21 sets the propulsive force to a greater value as the absolute value of the sliding amount increases. On the other hand, when the sliding amount of the icon G31 in the X-axis direction detected by the touch panel display 240 is a negative value (the sliding direction is the left direction along the X-axis), the controller 21 sets the propulsion direction to the left direction of the ship 1. Then, the controller 21 sets the propulsive force to a greater value as the absolute value of the sliding amount increases.

When the propulsion direction and the magnitude of the propulsive force in the right-left direction of the ship 1 are set by the method described above, the controller 21 corrects the set magnitude of the propulsive force according to the relative distance between the ship 1 and the mobile terminal 2. The correction method in that case may be the same as the method of correcting the magnitude of the propulsive force in the front-rear direction of the ship 1. Note that the correlation between the relative distance and the correction coefficient may be different from the case of correcting the magnitude of the propulsive force in the front-rear direction of the ship 1. For example, while the magnitude of the propulsive force in the front-rear direction of the ship 1 is determined as shown in FIG. 4A, the magnitude of the propulsive force in the right-left direction of the ship 1 may be determined as shown in FIG. 4B or 4C. In addition, the values of L1 and L2 may be different between a case where the magnitude of the propulsive force in the front-rear direction of the ship 1 is corrected and a case where the magnitude of the propulsive force in the right-left direction of the ship 1 is corrected.

As described above, when the propulsive force magnitude set according to the absolute value of the sliding amount is corrected, the controller 21 transmits the remote signal for propelling (translating) the ship 1 in the right direction or the left direction to the onboard device 140, as shown in FIG. 2B. The remote signal at that time includes a command for designating the right direction or the left direction as the propulsion direction and a command for designating the magnitude of the propulsive force after correction.

When the correction coefficient is determined to be “0”, the controller 21 may display a GUI component indicating that the remote operation of the ship 1 is not possible on the remote operation screen without transmitting the remote signal described above to the onboard device 140.

In addition, on the remote operation screen as shown in FIG. 2C, an operation of rotating the dial G32 of the second operation area OA32 in the circumferential direction (that is, a slide touch operation of sliding the dial G32 while touching the dial G32) is input. In response to the input, the controller 21 detects the rotation amount (sliding amount) of the dial G32 through the touch panel display 240. The controller 21 sets the turning direction and the propulsive force of the ship 1 in the right-left direction according to the detected sliding amount of the dial G32.

Here, the touch panel display 240 in the present embodiment is configured to output the sliding amount when the dial G32 is slid clockwise as a positive value, as shown in FIG. 3C. The touch panel display 240 is configured to output the sliding amount of the dial G32 when the dial G32 is slid counterclockwise as a negative value. Therefore, in the present embodiment, when the sliding amount of the dial G32 detected by the touch panel display 240 is a positive value (the sliding direction is clockwise), the controller 21 sets the turning direction to the right direction of the ship 1. Further, the controller 21 sets the propulsive force to a greater value as the absolute value of the sliding amount increases. On the other hand, when the sliding amount of the dial G32 detected by the touch panel display 240 is a negative value (the sliding direction is counterclockwise), the controller 21 sets the turning direction to the left direction of the ship 1 and sets the propulsive force to a greater value as the absolute value of the sliding amount increases.

When the turning direction and the magnitude of the propulsive force of the ship 1 are set by the method described above, the controller 21 corrects the set magnitude of the propulsive force according to the relative distance between the ship 1 and the mobile terminal 2. The correction method in that case may be the same as the method of correcting the magnitude of the propulsive force in the front-rear direction of the ship 1 or the method of correcting the magnitude of the propulsive force in the right-left direction of the ship 1.

Note that the correlation between the relative distance and the correction coefficient may be different between a case where the magnitude of the propulsive force in the front-rear direction of the ship 1 is corrected or a case where the magnitude of the propulsive force in the right-left direction of the ship 1 is corrected. For example, the magnitude of the propulsive force in the front-rear direction of the ship 1 or the magnitude of the propulsive force in the right-left direction of the ship 1 is determined as shown in FIG. 4A. On the other hand, the magnitude of the propulsive force in the turning direction of the ship 1 may be determined as shown in FIG. 4B or 4C. The values of L1 and L2 in a case where the magnitude of the propulsive force in the turning direction of the ship 1 is corrected may be different from the values of L1 and L2 in a case where the magnitude of the propulsive force in the front-rear direction of the ship 1 is corrected or in a case where the magnitude of the propulsive force in the right-left direction of the ship 1 is corrected.

As described above, when the magnitude of the propulsive force set according to the absolute value of the sliding amount is corrected, the controller 21 transmits the remote signal for turning the ship 1 in the right direction or the left direction to the onboard device 140, as shown in FIG. 2C. The remote signal at that time includes a command for designating the right turning direction or the left turning direction as the propulsion direction and a command for designating the magnitude of the propulsive force after correction.

When the correction coefficient is determined to be “0”, the controller 21 may display a GUI component indicating that the remote operation of the ship 1 is not possible on the remote operation screen without transmitting the remote signal described above to the onboard device 140.

In the setting of the magnitude of the propulsive force, as shown by the solid line of the bold line in FIGS. 3A to 3C, the propulsive force may be set to a value greater than zero under the condition that the absolute values of the sliding amounts of the icon G31 and the dial G32 are greater than zero. As shown by the dotted line of the bold line in FIGS. 3A to 3C, the propulsive force may be set to a value greater than zero under the condition that the absolute values of the sliding amounts of the icon G31 and the dial G32 are set to be greater than a predetermined value dz1. That is, a dead zone of a predetermined value dz1 may be set with respect to the sliding amounts of the icon G31 and the dial G32.

In addition, in a case where the ship 1 is propelled (translated) in an oblique direction (for example, right-front direction, right-rear direction, left-front direction, and left-rear direction), the user may slide the icon G31 of the first operation area OA31 in the oblique direction. In this case, the controller 21 of the mobile terminal 2 may detect the sliding amount in the X-axis direction and the sliding amount in the Y-axis direction through the touch panel display 240, and set the propulsion direction and the magnitude of the propulsive force of the ship 1 according to the detected sliding amount in the X-axis direction and the detected sliding amount in the Y-axis direction.

In a case where the translation and turning of the ship 1 are remotely operated at the same time, the user may perform an operation of sliding the icon G31 of the first operation area OA31 in the X-Y axis direction and an operation of sliding the dial G32 of the second operation area OA32 in the circumferential direction at the same time. In this case, the controller 21 of the terminal may set the translational direction and the magnitude of the propulsive force of the translation according to the sliding amount of the icon G31, and set the turning direction and the magnitude of the propulsive force of the turning according to the sliding amount of the dial G32.

In a case where another remote operation is performed after one remote operation has been performed, the controller 21 of the mobile terminal 2 may return the position of the icon G31 of the first operation area OA31 and the position of the dial G32 of the second operation area OA32 to the default positions after one remote operation has been performed.

### Flow of Processing

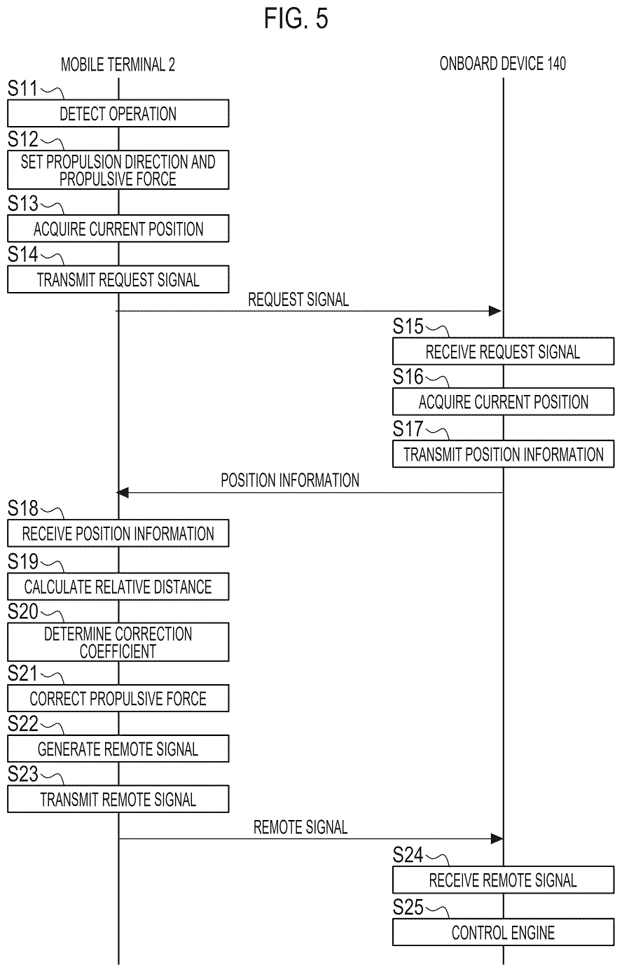

Here, a flow of processing executed by the remote ship operation system in the present embodiment will be described with reference to FIG. 5. FIG. 5 is a sequence diagram for describing processing executed by the remote ship operation system according to the present embodiment.

In FIG. 5, the slide touch operation is input by the user in a state where the remote operation screen as shown in FIGS. 2A to 2C described above is displayed on the touch panel display 240 of the mobile terminal 2. In response to the input, the controller 21 of the mobile terminal 2 detects the slide touch operation through the touch panel display 240 (S11). When the controller 21 of the mobile terminal 2 completes the execution of the process of S11, the controller 21 executes the process of S12.

In S12, the controller 21 of the mobile terminal 2 sets the propulsion direction and the magnitude of the propulsive force of the ship 1 in response to the slide touch operation detected in S11. In an example, the controller 21 of the mobile terminal 2 first determines whether the input slide touch operation is the operation (operation of sliding the icon G31 in the X-Y axis direction) performed in the first operation area OA31 or the operation (operation of sliding the dial G32 in the circumferential direction) performed in the second operation area OA32, through the touch panel display 240.

When determination is made that the input slide touch operation is the operation performed in the first operation area OA31, the controller 21 of the mobile terminal 2 sets the propulsion direction (the translational direction) of the ship 1 according to the output value of the touch panel display 240. Specifically, the controller 21 first determines whether the sliding direction of the icon G31 is the Y-axis direction or the X-axis direction according to the output value of the touch panel display 240.

In a case where the sliding direction of the icon G31 is the Y-axis direction, the controller 21 of the mobile terminal 2 determines whether the sliding amount in the Y-axis direction detected by the touch panel display 240 is a positive value or a negative value. When the sliding amount in the Y-axis direction detected by the touch panel display 240 is a positive value, the controller 21 of the mobile terminal 2 sets the propulsion direction to the forward direction of the ship 1. On the other hand, when the sliding amount in the Y-axis direction detected by the touch panel display 240 is a negative value, the controller 21 of the mobile terminal 2 sets the propulsion direction to the rearward direction of the ship 1. Then, the controller 21 of the mobile terminal 2 sets the magnitude of the propulsive force according to the absolute value of the sliding amount detected by the touch panel display 240. In an example, the controller 21 sets the propulsive force to be greater as the absolute value of the sliding amount increases, as shown in FIG. 3A.

In a case where the sliding direction of the icon G31 is the X-axis direction, the controller 21 of the mobile terminal 2 determines whether the sliding amount in the X-axis direction detected by the touch panel display 240 is a positive value or a negative value. When the sliding amount in the X-axis direction detected by the touch panel display 240 is a positive value, the controller 21 of the mobile terminal 2 sets the propulsion direction to the left direction of the ship 1. On the other hand, when the sliding amount in the X-axis direction detected by the touch panel display 240 is a negative value, the controller 21 of the mobile terminal 2 sets the propulsion direction to the left direction of the ship 1. Then, the controller 21 of the mobile terminal 2 sets the magnitude of the propulsive force according to the absolute value of the sliding amount detected by the touch panel display 240. In an example, the controller 21 sets the propulsive force to be greater as the absolute value of the sliding amount increases, as shown in FIG. 3B.

In addition, when the determination is made that the input slide touch operation is the operation performed in the second operation area OA32, the controller 21 of the mobile terminal 2 sets the propulsion direction (the turning direction) of the ship 1 according to the output value of the touch panel display 240. That is, the controller 21 of the mobile terminal 2 sets the propulsion direction of the ship 1 according to the sliding amount of the dial G32 detected by the touch panel display 240. In this case, when the sliding amount of the dial G32 detected by the touch panel display 240 is a positive value, the controller 21 of the mobile terminal 2 sets the propulsion direction to the right turning direction of the ship 1. On the other hand, when the sliding amount of the dial G32 detected by the touch panel display 240 is a negative value, the controller 21 of the mobile terminal 2 sets the propulsion direction to the left turning direction of the ship 1. Then, the controller 21 of the mobile terminal 2 sets the magnitude of the propulsive force according to the absolute value of the sliding amount detected by the touch panel display 240. In an example, the controller 21 sets the propulsive force to be greater as the absolute value of the sliding amount increases, as shown in FIG. 3C.

As described above, when the propulsion direction and the magnitude of the propulsive force of the ship 1 are set, the controller 21 of the mobile terminal 2 executes the process of S13. In S13, the controller 21 of the mobile terminal 2 acquires the current position of the mobile terminal 2 through the position acquisition unit 25. When the controller 21 of the mobile terminal 2 completes the execution of the process of S13, the controller 21 executes the process of S14.

In S14, the controller 21 of the mobile terminal 2 transmits the request signal to the onboard device 140 through the communication I/F 23.

When the request signal transmitted from the mobile terminal 2 is received by the communication I/F 143 of the onboard device 140 (S15), the controller 141 of the onboard device 140 acquires the current position of the ship 1 through the position acquisition unit 144 (S16). When the controller 141 of the onboard device 140 completes the execution of the process of S16, the controller 141 executes the process of S17.

In S17, the controller 141 of the onboard device 140 transmits the position information including the current position of the ship 1 to the mobile terminal 2 through the communication I/F 143.

When the position information transmitted from the onboard device 140 is received by the communication I/F 23 of the mobile terminal 2 (S18), the controller 21 of the mobile terminal 2 calculates the relative distance between the ship 1 and the mobile terminal 2 according to the current position of the ship 1 and the current position of the mobile terminal 2 (S19). The timing at which the controller 21 of the mobile terminal 2 acquires the current position of the mobile terminal 2 is not limited to the timing shown in FIG. 5, and may be a timing after the position information transmitted from the onboard device 140 is received (after the execution of S18 in FIG. 5). When the controller 21 of the mobile terminal 2 completes the execution of the process of S19, the controller 21 executes the process of S20.

In S20, the controller 21 of the mobile terminal 2 determines a correction coefficient for correcting the magnitude of the propulsive force set in S12. In an example, the controller 21 of the mobile terminal 2 may determine the correction coefficient according to the relative distance between the ship 1 and the mobile terminal 2 by using any of the maps shown in FIGS. 4A to 4C. When the controller 21 of the mobile terminal 2 completes the execution of the process of S20, the controller 21 executes the process of S21.

In S21, the controller 21 of the mobile terminal 2 multiplies the magnitude of the propulsive force set in S12 by the correction coefficient determined in S20 to correct the magnitude of the propulsive force. When the controller 21 of the mobile terminal 2 completes the execution of the process of S21, the controller 21 executes the process of S22.

In S22, the controller 21 of the mobile terminal 2 generates a remote signal including a command for designating the propulsion direction set in S12 and the magnitude of the propulsive force corrected in S21. When the controller 21 completes the execution of the process of S22, the controller 21 executes the process of S23.

In S23, the controller 21 of the mobile terminal 2 transmits the remote signal generated in S22 to the onboard device 140 through the communication I/F 23.

The remote signal transmitted from the mobile terminal 2 is received by the communication I/F 143 of the onboard device 140 (S24). In response to the reception, the controller 141 of the onboard device 140 controls the engines (bow thruster 110, right engine 120, and left engine 130) according to the propulsion direction and the magnitude of the propulsive force included in the remote signal.

When the correction coefficient determined in S20 is “0”, in other words, the magnitude of the post-correction propulsive force after correction may be “0” in S21. In this case, the controller 21 of the mobile terminal 2 may execute the processes of displaying the GUI component indicating that the remote operation of the ship 1 is not possible on the remote operation screen of the touch panel display 240 instead of the processes of S22 to S23. In this case, the onboard device 140 does not execute the processes of S24 and S25.

In the remote ship operation system described above, the correction coefficient is set to a smaller value when the relative distance between the ship 1 and the mobile terminal 2 is large compared to when the relative distance is small. As a result, the magnitude of the propulsive force that can be operated by the remote operation is automatically corrected to a smaller value when the relative distance between the ship 1 and the mobile terminal 2 is large compared to when the relative distance is small. As a result, the safety of the ship 1 and the periphery of the ship 1 can be improved in a case where the user of the mobile terminal 2 has difficulty in visually grasping the ship 1 and the periphery of the ship 1, such as in a case where the relative distance between the ship 1 and the mobile terminal 2 is large. Further, the operability of the remote operation can be ensured in a case where the user of the mobile terminal 2 can easily visually grasp the ship 1 and the periphery of the ship 1, such as in a case where the relative distance between the ship 1 and the mobile terminal 2 is small.

### Modification

In the embodiment described above, the example has been described in which the correction of the magnitude of the propulsive force according to the relative distance between the ship 1 and the mobile terminal 2 is executed by the mobile terminal 2, but may instead be executed by the ship 1 (onboard device 140).

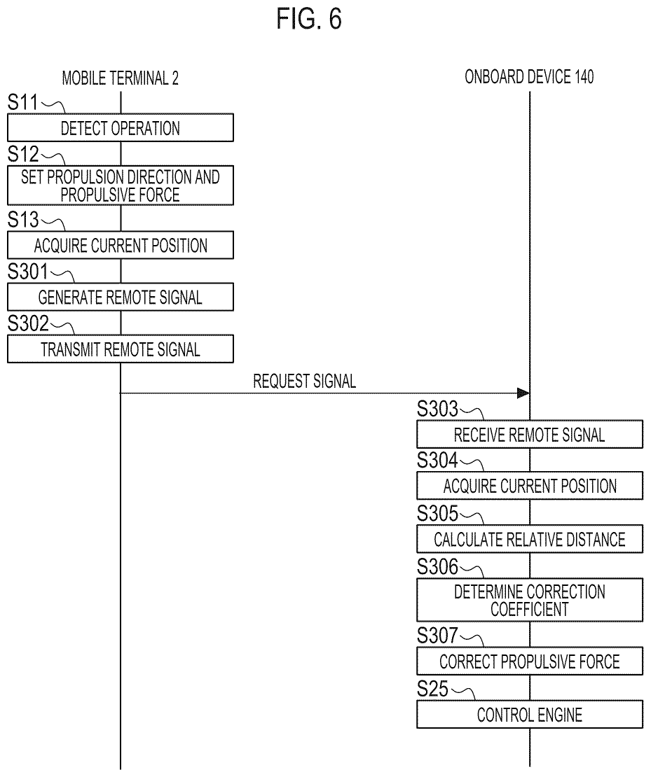

FIG. 6 is a sequence diagram for describing processing executed by the remote ship operation system according to the Modification. In FIG. 6, the same reference numerals are given to the same processes as those in the sequence diagram of FIG. 5 described above.

In FIG. 6, when the controller 21 of the mobile terminal 2 executes the processes of S11 to S13, the controller 21 executes the process of S301. In S301, the controller 21 of the mobile terminal 2 transmits the remote signal including the command for designating the propulsion direction and the magnitude of the propulsive force set in S12 and the current position of the mobile terminal 2 acquired in S13 to the onboard device 140 through the communication I/F 23.

When the remote signal transmitted from the mobile terminal 2 is received by the communication I/F 143 of the onboard device 140 (S303), the controller 141 of the onboard device 140 acquires the current position of the ship 1 through the position acquisition unit 144 (S304). When the controller 141 of the onboard device 140 completes the execution of the process of S304, the controller 141 executes the process of S305.

In S305, the controller 141 of the onboard device 140 calculates the relative distance between the ship 1 and the mobile terminal 2 according to the current position of the mobile terminal 2 included in the remote signal and the current position of the ship 1 acquired in S304. When the controller 141 of the onboard device 140 completes the execution of the process of S305, the controller 141 executes the process of S306.

In S306, the controller 141 of the onboard device 140 determines a correction coefficient for correcting the magnitude of the propulsive force included in the remote signal. The method of determining the correction coefficient may be the same as the method determined by the controller 21 of the mobile terminal 2 in the embodiment described above. In this case, the map shown in FIGS. 4A to 4C may be stored in the storage unit 142 of the onboard device 140. When the controller 141 of the onboard device 140 completes the execution of the process of S306, the controller 141 executes the process of S307.

In S307, the controller 141 of the onboard device 140 multiplies the magnitude of the propulsive force included in the remote signal by the correction coefficient determined in S306 to correct the magnitude of the propulsive force. When the controller 141 of the onboard device 140 completes the execution of the process of S307, the controller 141 executes the process of S25. In S25 in the Modification, the controller 141 of the onboard device 140 controls the engines (bow thruster 110, right engine 120, and left engine 130) according to the propulsion direction included in the remote signal and the magnitude of the propulsive force corrected in S307.

With the remote ship operation system according to the Modification, the same operations and effects as those in the embodiment described above can be obtained.

### Others

The embodiment and modification described above are merely examples, and the present disclosure can be appropriately modified and implemented within the scope of the spirit of the present disclosure. For example, instead of correcting the magnitude of the propulsive force according to the correction coefficient, the upper limit value of the magnitude of the propulsive force may be smaller when the relative distance between the ship 1 and the mobile terminal 2 is large compared to when the relative distance is small. In addition, the target of the correction based on the relative distance between the ship 1 and the mobile terminal 2 may be the control speed of the magnitude of the propulsive force instead of the magnitude of the propulsive force. In this case, the control speed (for example, a gain in a case where the magnitude of the propulsive force is controlled by proportional control and/or integral control) may be corrected such that the speed until the magnitude of the propulsive force reaches the target value (the magnitude of the propulsive force set in the mobile terminal 2) is reduced when the relative distance between the ship 1 and the mobile terminal 2 is large compared to when the relative distance is small. As a result, the response of the ship 1 to the remote operation can be made slower when the relative distance is large compared to when the relative distance is small. As a result, it is possible to improve the safety of the ship 1 and the periphery of the ship 1 in a case where the relative distance between the ship 1 and the mobile terminal 2 is large, while ensuring the operability of the remote operation in a case where the relative distance between the ship 1 and the mobile terminal 2 is small.

In addition, data communication between the onboard device 140 and the mobile terminal 2 may be performed through a server. In this case, the correction of the magnitude of the propulsive force according to the relative distance between the ship 1 and the mobile terminal 2 may be executed by the server.

The present disclosure can also be realized by supplying a computer program (information processing program) in which the functions described in the above embodiment are implemented to a computer, and reading and executing the program by one or more processors possessed by the computer. Such a computer program may be provided to the computer by a non-transitory computer-readable storage medium that can be connected to the computer's system bus, or may be provided to the computer via a network. The non-transitory computer-readable storage medium is a recording medium on which information, such as data and a program, can be accumulated by an electrical, magnetic, optical, mechanical, or chemical action and can be read through the computer or the like.

Examples of such a recording medium include any type of disk, such as a magnetic disk (a floppy (registered trademark) disk or an HDD) or an optical disk (a CD-ROM, a DVD disk, or a Blu-ray disk). The recording medium may be a medium, such as ROM, RAM, EPROM, EEPROM, a magnetic card, a flash memory, an optical card, or a solid state drive (SSD).

What is claimed is:

1. A remote controller configured to remotely operate a ship, the remote controller comprising a controller configured to execute:
detecting an operation of designating a magnitude of a predetermined propulsive force of the ship;
detecting a current position of the remote controller via a sensor mounted on the remote controller;
receiving, through wireless communication with the ship, a current position of the ship detected by a sensor mounted on the ship;
calculating a relative distance between the current position of the ship and the current position of the remote controller;
correcting, according to the relative distance, the magnitude of the predetermined propulsive force designated by the operation; and
transmitting, to the ship, a remote signal including a command for controlling the predetermined propulsive force according to the magnitude of the predetermined propulsive force after the correction.

2. A terminal configured to remotely operate a ship, the terminal comprising a controller configured to execute:
receiving an input of an operation for controlling a predetermined propulsive force of the ship;
acquiring a current position of the ship and a current position of the terminal in response to receiving the input of the operation;
calculating a relative distance between the current position of the ship and the current position of the terminal;
determining a control amount of the predetermined propulsive force according to the relative distance; and
transmitting, to the ship, a remote signal including a command for controlling the predetermined propulsive force according to the control amount that is determined.

3. The terminal according to claim 2, wherein:
the control amount includes a magnitude of the predetermined propulsive force, and
determining the control amount includes determining the magnitude of the predetermined propulsive force such that, when the relative distance is large, a ratio of the magnitude of the predetermined propulsive force to an operation amount of the operation is smaller compared to when the relative distance is small.

4. The terminal according to claim 2, wherein:
the control amount includes a control speed of the predetermined propulsive force, and
determining the control amount includes setting the control speed to be slower when the relative distance is large compared to when the relative distance is small.

5. An onboard device configured to be mounted on a ship that is remotely operated by a terminal, the onboard device comprising a controller configured to execute:
receiving, from the terminal, a remote signal including a control amount for controlling a predetermined propulsive force of the ship and a current position of the terminal;
acquiring a current position of the ship in response to receiving the remote signal;
calculating a relative distance between the current position of the ship and the current position of the terminal;
correcting the control amount according to the relative distance; and
controlling the predetermined propulsive force according to the control amount after the correction.
